(19) United States
(12) Patent Application Publication
(10) Pub. No.: US 2007/0096918 A1
(43) Pub. Date: May 3, 2007

(54) Package opened indicating device

(76) Inventors: Jorge Badillo, Rincon, PR (US); Salil Pradhan, San Jose, CA (US); Alipio Caban, Arecibo, PR (US); Bill Serra, Montara, CA (US); Geoff Lyon, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,064

(22) Filed: Nov. 1, 2005

(51) Int. Cl. G08B 13/14; G08B 21/00

(52) U.S. Cl. 340/572.8; 340/686.1; 340/665

(57) ABSTRACT

An indicating device configured to indicate that a package has been opened includes a voltage generator configured to convert a mechanical stress caused by opening of the package into a voltage and a circuit configured to employ the voltage to create a package opened indicator. The device also includes a data storage device configured to store the package opened indicator as electronic data.

### RELATED APPLICATION

U.S. patent application Ser. No. (Atty Docket No. 200405361-1), entitled Seal Method and System for Packages, by Geoff M. Lyon et al., is hereby incorporated by reference in its entirety.

### BACKGROUND

Products are often sent through a supply chain between the original source, such as a manufacturer, and the final destination, such as a consumer. The products may be tampered with at any number of different points along the supply chain. For example, a wholesaler may receive goods that have been tampered with, which it passes on to a retailer, or directly to the consumer.

Manufacturers typically attempt to protect products to prevent tampering of the products by providing features that indicate that the products have been opened. Some approaches that manufacturers have used include placing seals, which often include holograms, on the products, which may break when the products are opened. These approaches provide some deterrence; however, the seals may be duplicated, such that, a broken seal may be replaced to make it appear as if the product has not been opened.

### SUMMARY

A device configured to indicate that a package has been opened is described herein. The device includes a voltage generator configured to convert a mechanical stress caused by opening of the package into a voltage and a circuit configured to employ the voltage to create a package opened indicator. The device also includes a data storage device configured to store the package opened indicator as electronic data.

### BRIEF DESCRIPTION OF THE DRAWINGS

Features of the present invention will become apparent to those skilled in the art from the following description with reference to the figures, in which:

FIG. 1A illustrates a schematic diagram of an indicating device associated with a package, according to an embodiment of the invention.

FIG. 1B illustrates a block diagram of a system for including a package identifier on a package, according to an embodiment of the invention.

FIG. 2 illustrates an example of a system through which a package may be determined as having been opened, according to an embodiment of the invention.

FIG. 3 illustrates an example of a supply chain for the sale of pharmaceutical products, according to an embodiment of the invention.

FIG. 4 illustrates a block diagram of an identifying system according to an embodiment of the invention.

FIG. 5A shows a flow diagram of a method for indicating that a package has been opened, according to an embodiment of the invention.

FIG. 5B shows a flow diagram of a method for determining whether a package has been opened, according to an embodiment of the invention.

FIG. 6 illustrates a computer system, which may be employed to perform one or more steps in FIG. 5B, according to an embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

As described in greater detail below, a package may be equipped with components designed to detect and indicate whether the package has been opened. The indication of whether the package has been opened, for example, is in electronically readable form to render it relatively more difficult to conceal that the package has been opened. In addition, the indication that the package has been opened may be created through conversion of the force required to open the package.

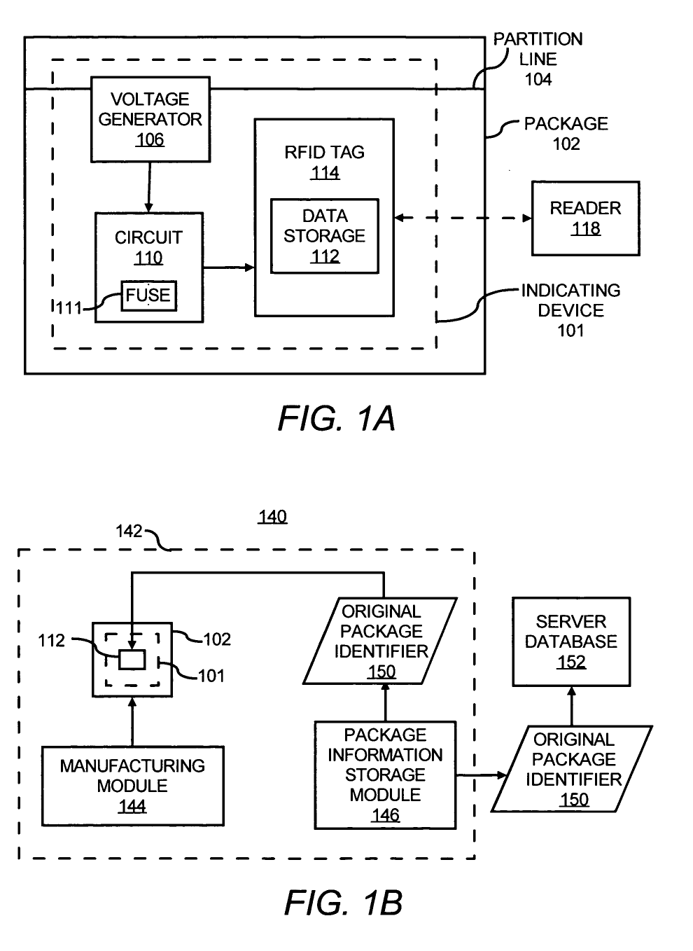

With reference first to FIG. 1A, there is shown a schematic diagram of an indicating device 101 associated with a package 102, according to an example. It should be readily apparent that the indicating device 101 depicted in FIG. 1A represents a generalized illustration and that other features may be added or existing features may be removed or modified without departing from a scope of the indicating device 101. In addition, the package 102 may comprise any reasonably suitable type of package 102, such as, a bottle, a box, or other suitable container for housing products.

Generally speaking, the indicating device 101 includes features that enable identification of whether the package 102 was opened. Through use of these features, a user may determine whether the package 102 was previously opened, which may be an indication that the package 102 or the products contained therein have been tampered with, and therefore, that the products contained in the package 102 may be unsafe.

As shown in FIG. 1A, the package 102 includes a partition line 104. The partition line 104 generally indicates a location where the package 102 may be opened. For instance, in the case where the package 102 comprises a bottle, the partition line 104 may indicate an interface location between the bottle and a cap. As another example, if the package 102 comprises a container designed to be torn open, the partition line 104 may indicate a location in the container where the container is to be torn open.

Positioned along the partition line 104 is a voltage generator 106. The voltage generator 106 is configured to generate a voltage from the energy generated when the package 102 is opened along the partition line 104. The voltage generator 106 may comprise a material, such as, piezoelectric material, that generates a voltage when mechanically stressed through, for instance, deformation, breaking, etc., of the voltage generator 106. Examples of the voltage generator 106 include piezoelectric voltage sources or piezoelectric power sources as are known in the art.

The voltage generator 106 may be affixed or applied onto the package 102 in a variety of manners. For instance, the voltage generator 106 may comprise a seal that is adhesively attached to the package 102 at a position along the partition line 104. In addition or alternatively, the voltage generator 106 may be applied onto the package 102 through an induction sealing process. As another example, the voltage generator 106 may be printed onto the package 102. In any event, the voltage generator 106 may be positioned either inside or outside of the package 102.

The circuit 110 is configured to use the voltage from the voltage generator 106 to create a package opened indicator. In one embodiment, creating a package opened indicator includes storing and/or altering a bit stored in a data storage device 112. For example, the act of opening the package 102 may provide sufficient electrical energy for a bit to be created or altered by the circuit 110.

In one embodiment, the circuit 110 includes a fuse 111. If the package 102 is opened, the voltage generator 106 generates a voltage which blows the fuse 111. The circuit 110 detects the blown fuse and stores or alters a bit in the data storage 112. For example, the fuse 11 is blown, creating an open circuit that is detected by the circuit 110. The circuit 110 then stores or alters a bit in the data storage 112. In one example, the data storage 112 is operable to store a predetermined amount of data, such as 16-bits. The circuit 110, for example, writes a “1” in one of the 16-bit bit positions of the data storage 112 to indicate that the package 102 has been opened. In this example, the “1” is the package open indicator, which is value in a predetermined storage location. The remaining bits may be used to store other data, such as a package identifier. In another example, the package identifier is altered. For example, the package identifier is 16 bits, and the circuit 110 alters one of the bits to indicate that the package 102 has been opened. In this example, the altered bit or the package identifier as a whole with the altered bit is the package opened indicator.

As described in greater detail below, the information pertaining to the package opened indicator may be evaluated to determine whether the package 102 has been opened. This information may be compared with predetermined information to determine whether one or more of the bits stored in the data storage device 112 or represented by the circuit 110 has changed due to the creation or alteration of the bit as described above. For instance, the package identifier stored in the data storage device 112 may be altered through creation or alteration of one or more bits of the package identifier due to opening of the package 102. The modified package identifier may be compared with the original package identifier to determine whether the package 102 was previously opened.

The data storage 112 is shown as the data storage for the RFID tag 114. It will be apparent to one of ordinary skill in the art that the data storage 112 may be separate from the RFID tag 114 and a package open indicator may be written from the data storage 112 to the RFID tag 114 and then transmitted to the reader 118. The RFID tag 114 transmits the package identifier and/or the package open indicator to the reader 118, for example, when interrogated, such as known in the art. The RFID tag 114 may include a passive, active, or semi-active RFID tag as is known in the art.

The voltage generator 106 is used to generate a voltage when the package 102 is opened. In one embodiment described above, the voltage is used to blow the fuse 111 to indicate the package 102 has been opened. The voltage generated by the voltage generator 106 may be used to power the circuit 110. For example, the voltage generator 106 may include a piezoelectric power source that generates power when the package 102 is opened.

The indicating device 101 may be affixed or applied onto the package 102 in a variety of manners either during or after fabrication of the package 102. For instance, one or more of these components may be adhesively attached to the package 102. As another example, one or more of these components may be printed onto the package 102.

FIG. 1B illustrates a simplified block diagram 140 of a system 142 for including a package identifier on the package 102, according to an example. It should be apparent that the system 142 depicted in FIG. 1B represents a generalized illustration and that other features may be added or existing features may be removed or modified without departing from a scope of the system 142.

In addition to the elements depicted in FIG. 1A, the system 142 is also depicted as including a manufacturing module 144 and a package information storage module 146. The manufacturing module 144 generally denotes one or more devices configured to manufacture the package 102 to include the components described above with respect to FIG. 1A. By way of example, the manufacturing module 144 may include a device configured to fabricate the physical structure of the package 102 and a device configured to apply a label onto the package 102. As another example, the manufacturing module 144 may include a device configured to affix or apply the indicating device 101 onto the package 102. The manufacturing module 144 may further include a device configured to connect the components of the indicating device 101 such that at least one of data and power may be transmitted between these components.

The manufacturing module 144 may also include a device configured to seal the package 102. In one embodiment, the device is configured to attach the voltage generator 106 to the package 102 through an induction sealing process. In any regard, the device may provide a seal along the partition line 104 shown in FIG. 1A configured to release a predetermined amount of energy when the package 102 is opened along the partition line 104.

The package information storage module 146 may include software or a device for generating an original package identifier 150, which may include a package identifier for the package 102. For example, the package information storage module 146 may generate the original package identifier 150 using an algorithm or the original package identifier 150 may be pre-determined and the package information storage module 146 retrieves the pre-determined original package identifier 150 from a storage device.

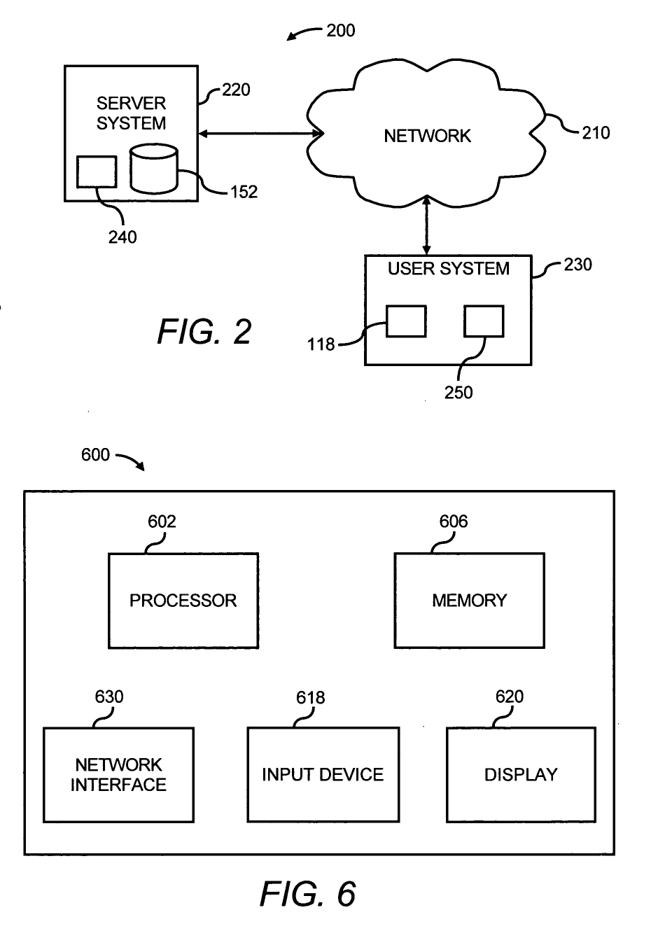

As shown in FIG. 1B, the package information storage module 146 may store the original package identifier 150 in the data storage device 112 of the package 102, either before or after the affixing process. In addition, or alternatively, the original package identifier 150 may include a value that may be changed if the package 102 is opened. In this regard, the original package identifier 150 may be used to determine whether the package 102 has been opened. The package information storage module 146 may also store the original package identifier 150 in a server database 152, which may be part of a server system as described herein below with respect to FIG. 2. In another embodiment, the package information storage module 146 retrieves a pre-determined original package identifier from the server database 152, and then stores the original package identifier in the data storage device 112 of the package 102.

The original package identifier 150 may be substantially unique for each package 102 manufactured by the manufacturing module 144. Alternatively, the original package identifier 150 may be the same for a number of packages 102. For instance, sets or subsets of packages 102 may have the same original package identifiers 150.

FIG. 2 illustrates a simplified example of a system 200 through which a package 102 may be determined as having been opened. The package opened identifying system 200 may additionally be implemented to determine the authenticity of the package 102. The package opened identifying system 200 includes a network 210, a server system 220, and a user system 230. The server system 220 and the user system 230 may include any reasonably suitable type of computer system, such as the computer system described herein below with reference to FIG. 6. The server system 220 may include a network interface including software and/or hardware, and serving software (not shown) for communicating with other systems connected to the server system 220 through the network 210. The network 210 may include any type of network, including a LAN, a WAN, the Internet, etc.

The server system 220 may include a package identifier module 240 and the server database 152. The user system 230 may include, for instance, the reading device 118 and a destination output 250, which may be used to receive and display information from the server system 220. In one regard, the user system 230 may be used to submit information pertaining to a package 102 to the server system 230 to determine whether the package 102 has been opened. In addition, the user system 230 may be used to transmit and receive information used to authenticate the package 102. The user system 230 may be used to submit information to the server system 220 through, for instance, a website administered by the server system 220.

The server system 220 may implement the package identifier module 240 to determine whether a package 102 has been opened. In one example, the package identifier module 240 may be employed to compare the original package identifier 150 with package information stored in the data storage device 112 through. If the stored package information matches the original package identifier 150, the server system 220 may output an indication that the package 102 has not been opened. However, if the stored package information does not match the original package identifier 150, the server system 220 may output and indication that the package 102 has been opened. A match may not occur, for instance, if the original package identifier 150 stored in the data storage device 112 has been altered through opening of the package 102 as described above.

The server system 220 may transmit a message to the user system 230 indicating that the package 102 has either been opened or not opened via the network 210. The message transmitted by the server system 220 may include a message sent to a browser of the user system 230, an email or other type of message, including facsimiles, etc.

Although the user system 230 and the server system 220 have been illustrated and described as comprising separate elements, the functionalities of these systems may be combined into a single system. Thus, for instance, the user system 230 may include the functionalities of the server system 220 and may thus be used to determine if a package 102 has been opened without requiring data transfer with the server system 220.

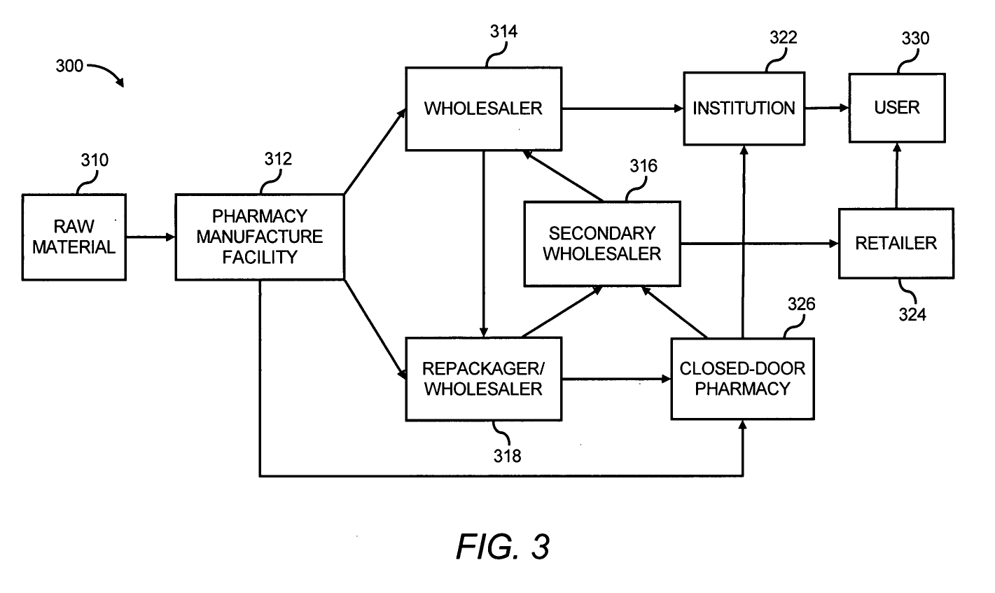

In addition, the package opened identifying system 200 may be used to determine whether a package 102 has been opened at any point of a supply chain, from the manufacturer to the customer. As an example, FIG. 3 illustrates a pharmaceutical supply chain and use of the package opened identifying system 200 in FIG. 2 in a pharmaceutical supply chain 300. It should be apparent that the package opened identifying system 200 may be used in supply chains for many product types without departing from a scope of the package opened identifying system 200.

With reference now to FIG. 3, there is shown a simplified example of a supply chain 300 for the sale of pharmaceutical (“pharma”) products. As shown in FIG. 3, raw materials 310 are received by a pharma manufacturing facility (“PMF”) 312. The PMF 312 sends the manufactured pharma products to a wholesaler 314 or a repackager/wholesaler 318. The wholesaler 314 may sell the pharma products to institutions 322, such as pharmacies, hospitals, nursing homes or hospices, or retailers 324, which sell the pharma products to individual users 330. The wholesaler 314 may also send some or all of its received pharma products to the repackager/wholesaler 318.

The repackager/wholesaler 318 may sell the pharma products to closed-door pharmacies 326. The closed door pharmacies 326 may sell the pharma products to institutions 322, such as hospitals, nursing homes or hospices. The PMF 312 may also directly provide pharma products to the closed-door pharmacies 326.

At any point along the supply chain 300, a package 102 manufactured at the PMF may be opened by someone other than the end user 330. Due to the number of entities handling the pharma products as they progress through the supply chain 300, pharmacies 324 and institutions 322 may receive pharma packages 102 that have been tampered with or opened. For example, secondary wholesalers 316 may receive opened packages 102 products, which the secondary wholesalers 316 may sell to retailers 324 or wholesalers 314, introducing the opened packages 102 into the supply chain 300.

The package opened identifying system 200 in FIG. 2 may be used at any point along the supply chain 300 determine whether a package 102 has been opened. In this example, the server system 220 used to determine whether the pharma products have been opened may be administered by the PMF 312 or administered by an agent of the PMF 312. The user system 230 may be located at any of the other locations in the supply chain 300, including the institution 322, the retailers 324, closed-door pharmacies 326, the wholesaler(s) 314, repackager/wholesaler(s) 318, secondary wholesaler(s) 316, or individual user 330. In addition, the user system 230 may be located at any point outside of the supply chain 300 where it is desired to determine whether a package 102 has been opened.

The embodiments described herein are not limited for use in a pharmaceutical supply chain, and may be used for authenticating any device or item that may store or otherwise include a package identifier.

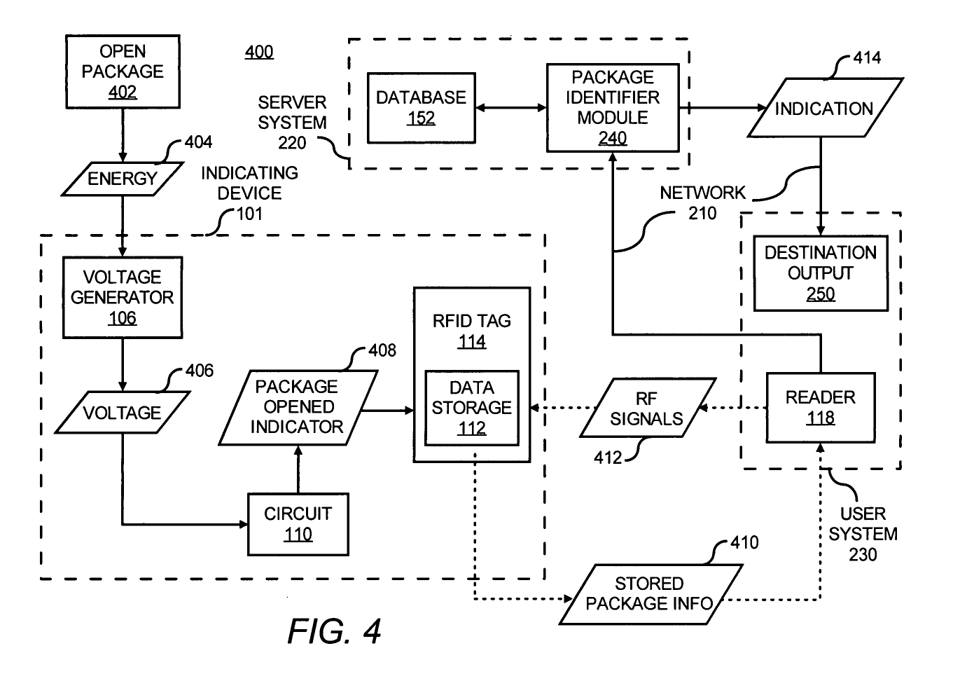

An example of an identifying system 400 for identifying whether a package has been opened is depicted in FIG. 4. It should be readily apparent that the identifying system 400 depicted in FIG. 4 represents a generalized illustration and that other features may be added or existing features may be removed or modified without departing from a scope of the identifying system 400.

The identifying system 400 is depicted as including many of the components described above with respect to FIGS. 1A, 1B and 2. More particularly, the identifying system 400 depicts the indicating device 101 associated with the package 102, the server system 220, and the user system 230. In one regard, the identifying system 400 provides an illustration of one manner in which these components interact with each other.

As shown, when the package 102 is opened, as indicated as open package 402, energy 404 is imparted onto the voltage generator 106. More particularly, when the package 102 is opened 402, energy 404 is imparted onto the voltage generator 106 through the mechanical stress associated with opening of the package 102.

The voltage generator 106 generates energy in the form of a voltage 406 from the energy 404 received when the package 102 is opened. The voltage supplied to the circuit 110 may cause the circuit 110 to store a package opened indicator 408 in the data storage device 112. The circuit 110 may store a package opened indicator 408 by one or more of storing and altering one or more bits stored in the data storage device 112.

The package information 410 stored in the data storage device 112 may be retrieved by the reader device 118. For example, the reader 118 may interrogate the RFID 114 to receive the stored package information 410. The stored package information 410 may include one or both of a package opened indicator 408 and a package identifier.

The stored package information 410 may be transmitted to the server system 220 over the network 210. The package identifier module 240 may evaluate the package information 410 to determine whether the package 102 has been opened. In one example, the package identifier module 240 may compare the package information 410 with the original package identifier 150 stored in the database 152. If the values for the package information 410 do not match the original package identifier 150, the package identifier module 240 may determine that the package 102 has been opened. In another example, the package identifier module 240 may compare values of the package opened indicator 408 with other stored values to determine whether there is a match.

The package identifier module 240 may also transmit an indication 414 as to whether the package 102 has been opened to the destination output 250 of the user system 230. As such, a user along any point in the supply chain 300, may implement the identifying system 400 to determine whether a package 102 has been opened.

According to another example, the user system 230 may be employed to determine whether the package 102 has been opened without requiring communication with the server system 220. In this example, the user system 230 may be programmed to determine whether there is a difference in a value read from the indicating device 101 and a predetermined value. The predetermined value may have been stored in the user system 230 or the user system 230 may retrieve the predetermined value from the indicating device 101, in which case, the predetermined value would have also been stored in the data storage device 112.

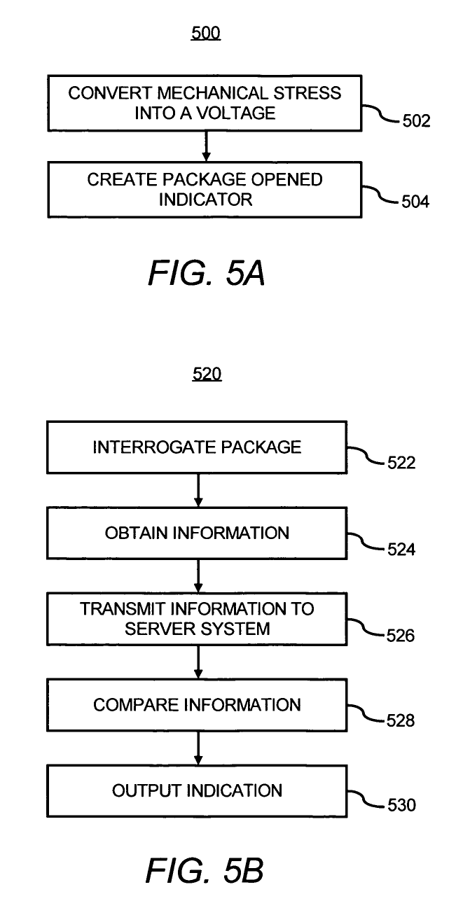

With reference to FIG. 5A, there is shown a flow diagram of a method 500 for indicating that a package 102 has been opened. It is to be understood that the following description of the method 500 is but one manner of a variety of different manners in which an example of the invention may be practiced. It should also be apparent to those of ordinary skill in the art that the method 500 represents a generalized illustration and that other steps may be added or existing steps may be removed, modified or rearranged without departing from a scope of the method 500.

In the method 500, at step 502, a mechanical stress caused by opening of the package 102 is converted into a voltage. At step 504, a package opened indicator is created through receipt of the voltage, such as described with respect to FIGS. 1A and 4. As described in greater detail above, the package opened indicator is readable by an electronic device and may be used to identify whether the package 102 has been opened. Manners in which the package opened indicator may be evaluated are described in greater detail with respect to FIG. 5B.

More particularly, FIG. 5B shows a flow diagram of a method 520 for determining whether a package 102 has been opened. It is to be understood that the following description of the method 520 is but one manner of a variety of different manners in which an example of the invention may be practiced. It should also be apparent to those of ordinary skill in the art that the method 520 represents a generalized illustration and that other steps may be added or existing steps may be removed, modified or rearranged without departing from a scope of the method 520.

The description of the method 520 is made with reference to FIG. 4, and thus makes reference to the elements cited therein. It should, however, be understood that the method 520 is not limited to being implemented by the elements shown in FIG. 4 and may be implemented by more, less, or different elements as those shown in FIG. 4.

At step 522, the package 102 may be interrogated through use of a reader device 118. The interrogation may be in the form of RF signals 412 transmitted to a RFID tag 114 of the indicating components 101. In response to receipt of the RF signals 412, the RFID tag 114 may transmit information pertaining to the package opened indicator 408 to the reader device 118, as indicated at step 524. The information may be transmitted to the server system 220 at step 526. At step 528, the server system 220, and more particularly, the package identifier module 240 may compare the information with information stored in the database 152 to determine whether the package 102 has been opened. The server system 220 may additionally output an indication at step 530 as to whether the package 102 has been opened. In one regard, the server system 220 may output an indication to the destination output 250 of the user system.

Referring to FIG. 6, and also with reference to FIG. 2, a schematic diagram of a computer system 600 is shown in accordance with an embodiment. The computer system 600 shown may be used as a server in the system shown in FIG. 2. The computer system 600 may include one or more processors, such as processor 602, providing an execution platform for executing software. The computer system 600 also includes a memory 606, which may include Random Access Memory (RAM) where software is resident during runtime. Other types of memory such as ROM (read only memory), EPROM (erasable, programmable ROM), EEPROM (electrically erasable, programmable ROM) and data storage, such as hard disks, etc., may be used.

A user interfaces with the computer system 600 with one or more input devices 618, such as a keyboard, a mouse, a stylus, and the like and a display 620. A network interface 630 is provided for communicating with other computer systems. It will be apparent to one of ordinary skill in the art that FIG. 6 is meant to illustrate a generic computer system. Any type of computer system may be used. Furthermore, one or more components of the components of the computer system 600 are optional, such as the display and input devices, and other types of components may be used or substituted as is known in the art.

One or more of the steps of the operations shown in FIG. 5B may be implemented as software embedded on a computer readable medium, such as the memory 606, and executed by the processor 602. The steps may be embodied by a computer program, which may exist in a variety of forms both active and inactive. For example, there may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

It will be apparent to one of ordinary skill in the art that other known electronic components may be added or substituted in the computer system 600. In addition, the computer system 600 may include a system board or blade used in a rack in a data center, a conventional “white box” server or computing device, etc. Also, one or more of the components in FIG. 6 may be optional.

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. An indicating device comprising:
a voltage generator configured to convert a mechanical stress caused by opening of the package into a voltage;
a circuit configured to employ the voltage to create a package opened indicator; and
a data storage device configured to store the package opened indicator as electronic data.

2. The indicating device according to claim 1, further comprising:
a radio frequency identification tag configured to transmit the package opened indicator stored in the data storage device to a reader device.

3. The indicating device according to claim 1, wherein the package opened indicator comprises a bit that is one of created and altered by the circuit when the circuit receives the voltage from the voltage generator.

4. The indicating device according to claim 1, wherein the circuit comprises a fuse configured to break when the circuit receives the voltage from the voltage generator and wherein the broken fuse comprises the package opened indicator.

5. The indicating device according to claim 1, further comprising:
a power converter configured to convert the voltage generated by the voltage generator into power useable by the circuit.

6. The indicating device according to claim 1, wherein the data storage device further stores a package identifier for identifying the package.

7. The indicating device according to claim 6, wherein the package opened indicator comprises a modification to the package identifier.

8. The indicating device according to claim 1, wherein the voltage generator comprises a piezoelectric material configured to generate a voltage when mechanically stressed.

9. A method for identifying whether a package has been opened, said method comprising:
converting a mechanical stress caused by opening of the package into a voltage; and
creating a package opened indicator through receipt of the voltage, wherein the package opened indicator is readable by an electronic device to identify whether the package has been opened.

10. The method according to claim 9, wherein converting a mechanical stress further comprises generating the voltage through use of a piezoelectric element that generates a voltage when mechanically stressed.

11. The method according to claim 9, wherein creating a package opened indicator further comprises at least one of creating a bit and altering a bit through receipt of the voltage.

12. The method according to claim 11, wherein at least one of creating a bit and altering a bit further comprises destroying a circuit through application of the voltage, wherein the circuit represents a readable bit.

13. The method according to claim 9, further comprising:
interrogating the package;
obtaining information pertaining to the package opened indicator;
comparing the information with a predetermined value; and
outputting an indication as to whether the package was opened based upon the comparison.

14. The method according to claim 13, wherein the predetermined value comprises an original package identifier of the package and wherein creating a package opened indicator further comprises altering the package identifier, and wherein outputting an indication further comprises outputting an indication that the package was opened in response to the package identifier differing from the original package identifier.

15. The method according to claim 13, wherein interrogating the package further comprises interrogating the package with a radio frequency identification reader device.

16. A system for identifying whether a package has been opened, said system comprising:
an indicating device associated with the package, said indicating device comprising
a voltage generator configured to convert a mechanical stress caused by opening of the package into a voltage;
a circuit configured to create a package opened indicator in response to receipt of the voltage; and
a data storage device configured to store the package opened indicator; and
a determining system for determining whether the package has been opened based upon the package opened indicator.

17. The system according to claim 16, wherein the determining system further comprises:
a user system comprising a reader configured to interrogate the data storage device to receive information regarding the package opened indicator; and
a server system in communication with the user system, said server system being configured to determine whether the package was opened based upon the information regarding the package opened indicator.

18. The system according to claim 16, wherein the indicating components further includes a radio frequency identification (RFID) tag and wherein the reader comprises a RFID reader.

19. The system according to claim 16, wherein the server system includes a database and wherein an original package identifier is stored in the database and the data storage device.

20. The system according to claim 19, wherein the circuit is configured to alter the original package identifier stored in the data storage device when the voltage is received, and wherein the server system is further configured to compare the altered package identifier read from the data storage device with the original package identifier stored in the database to determine whether the package was opened.

21. The system according to claim 16, wherein the server system is associated with a manufacturer of the package and the user system is associated with one or more members of a supply chain, and wherein the user system is in communication with the server system over a network.

22. An apparatus for identifying whether a package has been opened, said apparatus comprising:
means for converting a mechanical stress caused by opening of the package into a voltage;
means for creating an electronically readable package opened indicator through receipt of the voltage; and
means for storing the electronically readable package opened indicator with the package.
